(19) United States
(12) Patent Application Publication
(10) Pub. No.: US 2026/0063939 A1
(43) Pub. Date: Mar. 5, 2026

(54) DISPLAY DEVICE

(71) Applicant: Sharp Display Technology Corporation, Kameyama City (JP)

(72) Inventors: Hirotoshi YASUNAGA, Kameyama City (JP); Hisashi Watanabe, Kameyama City (JP)

(21) Appl. No.: 19/316,189

(22) Filed: Sep. 2, 2025

(30) Foreign Application Priority Data
Sep. 5, 2024 (JP) 2024-153137

(51) Int. Cl. G02F 1/1333

(52) U.S. Cl. CPC G02F 1/133308

(57) ABSTRACT

A display device includes a display panel, a housing that stores the display panel and includes a bezel placed around the display panel in a plan view, a front plate placed on a viewer's side of the display panel, at least part of the front plate overlapping the bezel, and an adhesive member bonded to the front plate, in which the front plate includes a flat portion that does not overlap the bezel and an end portion that overlaps the bezel, when a plane obtained by virtually expanding a viewer-side face of the display panel is defined as a reference plane, a distance between a viewer-side face of the end portion and the reference plane is shorter than a distance between a viewer-side face of the flat portion and the reference plane, and at least part of the adhesive member overlaps the end portion.

### CROSS-REFERENCE TO RELATED APPLICATIONS

This application claims the benefit of priority to Japanese Patent Application Number 2024-153137 filed on Sep. 5, 2024. The entire contents of the above-identified application are hereby incorporated by reference.

### BACKGROUND

### Technical Field

The disclosure relates to a display device.

In recent years, studies have been conducted on ways to improve design of display devices that display desired images when a display screen is on, by making a display panel inconspicuous by harmonizing with surrounding components, a housing, and the like when the display device is off.

For example, JP 2023-72971 A discloses an optical layered body including a polarizing plate including a polarizer, a print layer provided along a periphery of the polarizing plate, and a first adhesive layer that contains a colorant in this order; and an image display device including a display element and the optical layered body in this order toward a viewing side, in which the optical layered body is placed such that the print layer is closer to the viewing side than the polarizing plate.

### SUMMARY

An object of the disclosure is to provide a display device that can achieve a good appearance and can be manufactured easily.

(1) A display device according to an embodiment of the disclosure includes a display panel, a housing configured to store the display panel and including a bezel placed around the display panel in a plan view, a front plate placed on a viewer's side of the display panel, at least part of the front plate overlapping the bezel, and an adhesive member bonded to the front plate, in which the front plate includes a flat portion not overlapping the bezel and an end portion overlapping the bezel, in a case in which a plane obtained by virtually expanding a viewer-side face of the display panel is defined as a reference plane, a distance between a viewer-side face of the end portion and the reference plane is shorter than a distance between a viewer-side face of the flat portion and the reference plane, and at least part of the adhesive member overlaps the end portion.

(2) In a display device according to an embodiment of the disclosure, in addition to the configuration in (1), the viewer-side face of the end portion is inclined relative to the reference plane.

(3) In a display device according to an embodiment of the disclosure, in addition to the configuration in (1) or (2), the distance between the viewer-side face of the end portion and the reference plane increases toward the flat portion.

(4) In a display device according to an embodiment of the disclosure, in addition to the configuration in (1), (2), or (3), the front plate does not include a light blocking portion.

(5) In a display device according to an embodiment of the disclosure, in addition to the configuration in (1), (2), (3), or (4), in a case in which the display panel has an x value of x1 and a y value of y1 in an xy chromaticity diagram measured from the viewer's side in a state where the display device is off, and the bezel has an x value of x2 and a y value of y2 in an xy chromaticity diagram measured from the viewer's side, an absolute value of a difference between x1 and x2 and an absolute value of a difference between y1 and y2 are both 0.02 or less.

(6) In a display device according to an embodiment of the disclosure, in addition to the configuration in (1), (2), (3), (4), or (5), a reflectance of the bezel is 50% or less, and a reflectance of the display panel is 50% or less in a state where the display device is off.

(7) A display device according to an embodiment of the disclosure further includes, in addition to the configuration in (1), (2), (3), (4), (5), or (6), a component between the bezel and the front plate, the component being identical to a component located closest to the viewer's side in the display panel.

(8) In a display device according to an embodiment of the disclosure, in addition to the configuration in (1), (2), (3), (4), (5), (6), or (7), the adhesive member is placed on a back side face of the end portion.

(9) In a display device according to an embodiment of the disclosure, in addition to the configuration in (1), (2), (3), (4), (5), (6), or (7), the adhesive member is placed on the viewer-side face of the end portion.

(10) In a display device according to an embodiment of the disclosure, in addition to the configuration in (1), (2), (3), (4), (5), (6), (7), (8), or (9), the end portion is a lens portion.

(11) A display device according to an embodiment of the disclosure further includes, in addition to the configuration in (1), (2), (3), (4), (5), (6), (7), (8), or (9), a facing member placed on the viewer's side of the end portion and overlapping the end portion.

(12) In a display device according to an embodiment of the disclosure, in addition to the configuration in (11), in a case in which the display panel has an x value of x1 and a y value of y1 in an xy chromaticity diagram measured from the viewer's side in a state where the display device is off, and the facing member has an x value of x3 and a y value of y3 in an xy chromaticity diagram measured from the viewer's side, an absolute value of a difference between x1 and x3 and an absolute value of a difference between y1 and y3 are both 0.02 or less.

(13) A display device according to an embodiment of the disclosure further includes, in addition to the configuration in (11) or (12), a storage section configured to store the housing, in which the facing member is part of the storage section.

(14) In a display device according to an embodiment of the disclosure, in addition to the configuration in (13), in a case in which the storage section has an x value of x4 and a y value of y4 in an xy chromaticity diagram measured from the viewer's side, and the front plate has an x value of x5 and a y value of y5 in an xy chromaticity diagram measured from the viewer's side, an absolute value of a difference between x4 and x5 and an absolute value of a difference between y4 and y5 are both 0.02 or less.

(15) In a display device according to an embodiment of the disclosure, in addition to the configuration in (11) or (12), the display device is embedded in a wall surface, and the facing member is part of the wall surface.

(16) In a display device according to an embodiment of the disclosure, in addition to the configuration in (15), in a case in which the front plate has an x value of x5 and a y value of y5 in an xy chromaticity diagram measured from the viewer's side, and the wall surface has an x value of x6 and a y value of y6 in an xy chromaticity diagram measured from the viewer's side, an absolute value of a difference between x5 and x6 and an absolute value of a difference between y5 and y6 are both 0.02 or less.

(17) In a display device according to an embodiment of the disclosure, in addition to the configuration in (1), (2), (3), (4), (5), (6), (7), (8), (9), (11), (12), (13), (14), (15), or (16), the back side face of the end portion is located on a back side relative to a back side face of the flat portion.

(18) In a display device according to an embodiment of the disclosure, in addition to the configuration in (1), (2), (3), (4), (5), (6), (7), (8), (9), (10), (11), (12), (13), (14), (15), (16), or (17), the front plate includes a design layer.

(19) In a display device according to an embodiment of the disclosure, in addition to the configuration in (1), (2), (3), (4), (5), (6), (7), (8), (9), (10), (11), (12), (13), (14), (15), (16), (17), or (18), local dimming is possible.

According to the disclosure, a display device capable of achieving a good appearance and manufacturing easily can be provided.

### BRIEF DESCRIPTION OF DRAWINGS

The disclosure will be described with reference to the accompanying drawings, wherein like numbers reference like elements.

FIG. 1 is a schematic plan view of a display device according to a first embodiment.

FIG. 2 is a schematic cross-sectional view taken along line X1-X2 in FIG. 1.

FIG. 3 is a schematic plan view of the display device according to the first embodiment, illustrating an aspect in which a front plate includes a design layer.

FIG. 4 is a schematic plan view of a typical display device, illustrating an aspect in which a front plate includes a design layer.

FIG. 5 is a schematic plan view of the display device according to the first embodiment, illustrating an aspect in which local dimming is possible.

FIG. 6 is a schematic cross-sectional view of the display device according to the first embodiment, illustrating an aspect in which a component that is the same as a component on a viewer's side of the display panel is provided between a bezel and the front plate.

FIG. 7 is a schematic plan view of the display device according to the first embodiment, illustrating the aspect in which the component that is the same as the component on the viewer's side of the display panel is provided between the bezel and the front plate.

FIG. 8 is a schematic cross-sectional view of a display device according to a first modified example of the first embodiment.

FIG. 9 is a schematic cross-sectional view of a display device according to a second embodiment.

FIG. 10 is a schematic perspective view illustrating an example of the display device according to the second embodiment.

FIG. 11 is a schematic perspective view illustrating another example of the display device according to the second

FIG. 12 is a schematic cross-sectional view of a display device according to a first modified example of the second embodiment.

FIG. 13 is a schematic cross-sectional view of a display device according to a second modified example of the second embodiment.

FIG. 14 is a schematic cross-sectional view of a display device according to a third embodiment.

FIG. 15 is a schematic cross-sectional view of a display device according to a first modified example of the third embodiment.

FIG. 16 is a schematic cross-sectional view of a display device according to a second modified example of the third embodiment.

FIG. 17 is a schematic cross-sectional view of a display device according to a third modified example of the third embodiment.

FIG. 18 is a schematic cross-sectional view of a display device according to a fourth embodiment.

FIG. 19 is a schematic plan view of a typical display device according to a first comparative embodiment.

FIG. 20 is a schematic cross-sectional view of the typical display device according to the first comparative

FIG. 21 is an enlarged schematic cross-sectional view for describing reflection of external light in a region surrounded by a dotted line in FIG. 20.

FIG. 22 is a schematic plan view of a typical display device according to a second comparative embodiment.

FIG. 23 is a schematic cross-sectional view of the typical display device according to the second comparative embodiment.

FIG. 24 is an enlarged schematic cross-sectional view for describing reflection of external light in a region surrounded by a dotted line in FIG. 23.

FIG. 25 is a schematic plan view of a typical display device according to a third comparative embodiment.

FIG. 26 is a schematic cross-sectional view of the typical display device according to the third comparative embodiment.

FIG. 27 is an enlarged schematic cross-sectional view for describing reflection of external light in a region surrounded by a dotted line in FIG. 26.

### DESCRIPTION OF EMBODIMENTS

The disclosure will be described in detail below through the presentation of embodiments with reference to the drawings, however, the disclosure is not limited only to these embodiments. In the following description, the same reference numerals will be appropriately used in common among the different drawings for the same parts or parts having similar functions, and repeated description thereof will be omitted as appropriate. Each of the aspects of the disclosure may be combined as appropriate within a scope that does not depart from the gist of the disclosure.

In this specification, when two directions (planes) are orthogonal to each other, an angle between the two directions (planes) is preferably in a range of 90°±3°, more preferably in a range of 90°±1°, and even more preferably in a range of 90°±0.5°. When two directions (planes) are parallel, an angle between the two directions (planes) is preferably in a range of 0°±3°, more preferably in a range of 0°±1°, and even more preferably in a range of 0°±0.5°.

In this specification, “viewer's side” means a side closer to a screen (display surface) of a display device, and “back side” means a side farther from the screen (display surface) of the display device. In this specification, plan view means a view from the viewer's side.

In this specification, a display device being on refers to a state in which light is emitted from the viewer's side of the display device. When a display panel is a liquid crystal panel, a display device being on refers to a state in which a backlight placed on a back side of the liquid crystal panel is on and the liquid crystal panel transmits light (white display state), and when the display panel is a self-luminous panel such as an OLED, a display device being on refers to a state in which the display panel is on. In this specification, a display device being off refers to a state in which no light is emitted from the viewer's side of the display device. To be specific, a display device being off refers to, when the display panel is a liquid crystal panel, a state in which a backlight is off, and a state in which backlights corresponding to regions (black display regions) of the display panel where no image is being displayed are off in a display device equipped with backlights that can be locally dimmed, and refers to, when the display panel is a self-luminous panel such as an OLED, a state in which the display panel is off. A state in which the display device is on is also referred to simply as “on” or “on state”. A state in which the display device is off is also referred to simply as “off” or “off state”.

### First Embodiment

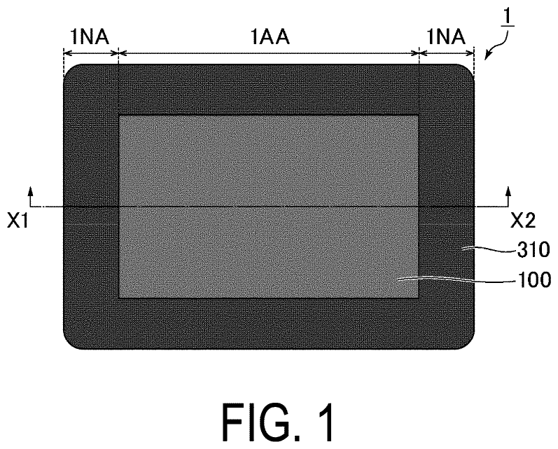

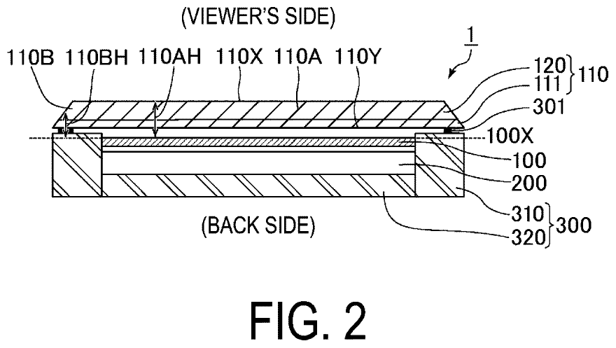

FIG. 1 is a schematic plan view of a display device according to a first embodiment. FIG. 2 is a schematic cross-sectional view taken along line X1-X2 in FIG. 1.

As illustrated in FIGS. 1 and 2, a display device 1 of the present embodiment includes a display panel 100, a housing 300 that stores the display panel 100 and includes a bezel (frame member) 310 placed around the display panel 100 in a plan view, a front plate 110 that is placed on a viewer's side of the display panel 100 and at least partially overlaps the bezel 310, and an adhesive member 301 bonded to the front plate 110. The front plate 110 includes a flat portion 110A that does not overlap the bezel 310 and an end portion 110B that overlaps the bezel 310. When a viewer-side face of the display panel 100 is virtually expanded to serve as a reference plane 100X, a distance between a viewer-side face 110X of the end portion 110B and the reference plane 100X is shorter than a distance between a viewer-side face 110X of the flat portion 110A and the reference plane 100X. At least part of the adhesive member 301 overlaps the end portion 110B. The display device 1 having such an aspect can make the adhesive member 301 less visible as illustrated in FIG. 1, thereby achieving a good appearance. In addition, in typical display devices, a print portion may be provided on a frame of a front plate to make an adhesive member invisible, but the display device 1 of the present embodiment is capable making the adhesive member 301 less visible without providing this print portion, and thus can be manufactured more easily than the typical display devices. As a result, manufacturing costs are reduced. Note that in this specification, overlapping refers to overlapping in a plan view.

### Display Panel

As illustrated in FIGS. 1 and 2, the display panel 100 has, in a plan view, a display region 1AA and a frame region 1NA placed around the display region 1AA. The frame region 1NA is a region that overlaps the bezel 310 in a plan view and is a region that is not involved in displaying images and the like on the display device. The display region 1AA is a region that overlaps the display panel 100 in a plan view. The display region 1AA is specifically a region including multiple pixels, and is a region where desired images and the like are displayed when the display device 1 is on.

Examples of the display panel 100 include a liquid crystal panel and a self-luminous panel. The liquid crystal panel is composed of, for example, a pair of substrates and a liquid crystal layer that is sandwiched between the pair of substrates and contains liquid crystal molecules. The pair of substrates may be a TFT substrate including multiple switching elements such as thin film transistors (TFTs) and a counter substrate. The TFT substrate or the counter substrate may include color filters of red, green, blue, or the like that overlap pixels described below.

The TFT substrate may be composed of a support substrate, gate wiring lines and source wiring lines intersecting the gate wiring lines placed on the support substrate, TFTs placed near intersections of the gate wiring lines and the source wiring lines, and pixel electrodes electrically connected to the TFTs. A region surrounded by the gate wiring lines and the source wiring lines is the pixel, and the color filters are arranged so as to overlap the corresponding pixels.

A common electrode is placed on the TFT substrate or the counter substrate. By applying a predetermined voltage between the pixel electrode and the counter electrode, the display device 1 generates an electrical field in the liquid crystal layer, controls an orientation direction of the liquid crystal molecules to adjust an amount of transmission of light emitted from a backlight 200 to the liquid crystal panel, thereby achieving an on state.

The liquid crystal panel includes a pair of polarizers, one of which is located on the viewer's side of the liquid crystal panel and another on the back side. The pair of polarizers may be absorptive linear polarizers each having a transmission axis that transmits only light in a specific polarization direction and an absorption axis orthogonal to the transmission axis. The pair of polarizers are arranged, for example, in crossed Nicols such that the transmission axes thereof are orthogonal to each other. In addition, between the TFT substrate and the liquid crystal layer, and between the counter substrate and the liquid crystal layer, an alignment film that controls the orientation direction of the liquid crystal molecules when no voltage is applied may be placed.

An example of the self-luminous panel is an organic light emitting diode (OLED) panel including multiple OLEDs. The self-luminous panel is a panel that can emit light by itself with light-emitting elements such as OLEDs inside the panel, and can emit light to the viewer's side without requiring an external light source such as a backlight.

A configuration of the organic light emitting diode is not particularly limited, and may be a configuration in which a cathode electrode, a light-emitting layer, and an anode electrode are layered in this order. The light-emitting layer may contain a fluorescent material, a phosphorescent material, or the like as a luminescent material. An electron transport layer may be placed between the cathode electrode and the light-emitting layer, and a hole transport layer may be placed between the light-emitting layer and the anode electrode.

The light-emitting elements such as OLEDs may be arranged in a matrix on a substrate on which, for example, gate wiring lines, source wiring lines, TFTs, and the like are formed, so that each TFT (each pixel) includes one light-emitting element. In the OLED panel, a region where multiple light-emitting elements are arranged is the display region. The multiple light-emitting elements may include red light-emitting elements, green light-emitting elements, and blue light-emitting elements. The self-luminous panel may include a circular polarizer on the viewer's side (front plate side, front side) from the viewpoint of reducing internal reflectance.

The display panel 100 may further include an anti-reflection film on the viewer's side of the polarizer such as the linear polarizer or the circular polarizer described above that is located on the viewer's side in the display panel 100. Examples of the anti-reflection film include known films such as an anti-reflection film (AR film) and an anti-glare film (AG film). As the AR film, for example, an AR film manufactured by Nitto Denko Corporation can be used. As the AG film, for example, an AG film manufactured by Nitto Denko Corporation can be used.

### Front Plate

The front plate 110 is a component placed on the viewer's side of display panel 100, and transmits at least part of light incident from the display panel 100. The front plate 110 preferably includes a transparent base material 111.

The transparent base material 111 may be, for example, a plate made of resin such as acrylic or polycarbonate, or a glass plate. The transparent base material 111 may have a flat surface or a curved surface.

From the viewpoint of maintaining high luminance of the display device 1, the transparent base material 111 preferably has a high transmittance, for example, a transmittance of 90% or more. From the viewpoint of suppressing blurring of display images, the transparent base material 111 preferably has a haze of 10% or less. In this specification, the transmittance refers to a total light transmittance, and is measured by a method in accordance with JIS K 7361-1:1997. The total light transmittance is a total light transmittance in a visible light region (e.g., wavelengths from 380 nm to 780 nm). The haze is measured by a method in accordance with JIS K 7136:2000. The total light transmittance can be measured, for example, using a turbidity meter such as “Haze Meter NDH 2000” manufactured by Nippon Denshoku Industries Co., Ltd. The haze can be measured, for example, using a turbidity meter such as “Haze Meter NDH 2000” manufactured by Nippon Denshoku Industries Co., Ltd.

A transmittance of a region of the front plate 110 that overlaps the display region 1AA is preferably 50% or more. With this aspect, the display device 1 can achieve an on state while maintaining high luminance. When the transmittance of the region of the front plate 110 that overlaps the display region 1AA is less than 50%, the luminance of the display device 1 may decrease, and display images may be difficult to see in a bright environment. The transmittance of the region of the front plate 110 that overlaps the display region 1AA is more preferably 70% or more. An upper limit of the transmittance of the front plate 110 is, for example, 90%.

The front plate 110 includes the flat portion 110A and the end portion 110B. The flat portion 110A and the end portion 110B of the present embodiment are adjacent to each other in a plan view. FIG. 2 illustrates a shape and arrangement of the flat portion 110A of the present embodiment. The front plate 110 at the flat portion 110A has a constant thickness, but may include a region having a different thickness. The flat portion 110A has at least a region that does not overlap the bezel 310, and may has a region that overlaps the bezel 310. The region that does not overlap the bezel 310 may be the “region that overlaps the display region 1AA” described above.

FIG. 2 illustrates a shape and arrangement of the end portion 110B of the present embodiment. That is, the end portion 110B is a region located at ends of the front plate 110 in a plan view. The end portion 110B has at least a region that overlaps the bezel 310, and the end portion 110B is entirely located within the region that overlaps the bezel 310. A thickness of the front plate 110 at the end portion 110B is less than the thickness of the front plate 110 at the flat portion 110A. In FIG. 2, the thickness of the front plate 110 at the end portion 110B is not constant, but decreases from a boundary with the flat portion 110A toward the end of the front plate 110.

In the present embodiment, the virtually expanding viewer-side face of the display panel 100 is served as the reference plane. That is, the reference plane can be generated by planarly expanding the viewer-side face of the display panel 100 to a region where the display panel 100 does not exist (e.g., a region where the bezel 310 exists). The reference plane can be used as a reference when expressing a distance in a cross-sectional direction of the display device (e.g., a distance in a direction from the viewer's side to the back side).

A distance 110BH between the viewer-side face 110X of the end portion 110B and the reference plane 100X is shorter than a distance 110AH between the viewer-side face 110X of the flat portion 110A and the reference plane 100X. The distance 110BH between the viewer-side face 110X of the end portion 110B and the reference plane 100X may or may not be constant. The distance 110BH is, for example, shorter than the distance 110AH by 0.3 μm or more. In a plan view, a width of the end portion 110B is, for example, from 0.1 cm to 1.5 cm.

The distance 110AH between the viewer-side face 110X of the flat portion 110A and the reference plane 100X is constant. The distance 110AH may be, for example, a distance between the viewer-side face 110X of the flat portion 110A at a central portion and the reference plane 100x. The distance 110AH is preferably from 50 μm to 10 mm. By using the front plate 110 having such a small thickness, it is possible to suppress blurring of an image of the display panel 100 viewed through the front plate 110.

It is preferable that the viewer-side face 110X of the end portion 110B be inclined relative to the reference plane 100X. The display device 1 having such an aspect can make the adhesive member 301 even less visible, thereby achieving a better appearance. The end portion 110B with a gradually thinner film thickness is easier to manufacture and can achieve higher strength than an end portion 110B with a uniformly thin film thickness.

It is preferable that the distance 110BH between the viewer-side face 110X of the end portion 110B and the reference plane 100X increase toward the flat portion 110A. The display device 1 having such an aspect can make the adhesive member 301 even less visible, thereby achieving an even better appearance. The end portion 110B with a gradually thinner film thickness is easier to manufacture and can achieve higher strength than an end portion 110B with a uniformly thin film thickness.

A back side face 110Y of the flat portion 110A is parallel to the reference plane 100X. A back side face 110Y of the end portion 110B is parallel to the reference plane 100X. The back side face 110Y of the end portion 110B is located on the same plane as the back side face 110Y of the flat portion 110A. The display device having such an aspect can be easily manufactured because a shape of the front plate 110 is simple.

The front plate 110 preferably does not include a light blocking portion. In a manufacturing process of the display device 1 having such an aspect, a step of providing a light blocking portion in the front plate 110 is not required, so that the display device 1 can be manufactured more easily.

The light blocking portion has a function of blocking light. The light blocking portion may have a light absorption rate of 50% or more. A light absorption rate of 80% or more is preferred, and a light absorption rate of 95% or more is more preferred. As a measuring method of the light absorption rate of the light blocking portion, a common reflectance measurement and a common transmittance measurement are performed. Then, the light absorption rate is calculated by subtracting the reflectance and the transmittance from 100%.

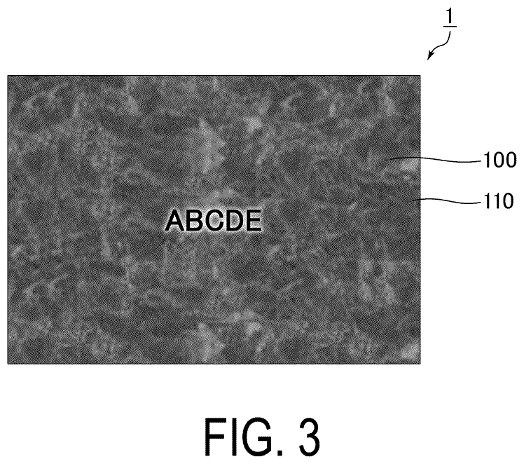

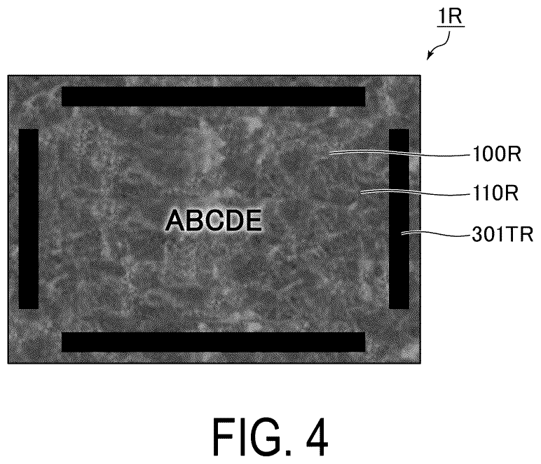

FIG. 3 is a schematic plan view of the display device according to the first embodiment, illustrating an aspect in which a front plate includes a design layer. FIG. 4 is a schematic plan view of a typical display device, illustrating an aspect in which a front plate includes a design layer. FIGS. 3 and 4 illustrate a case where the design layer has a marble pattern.

As illustrated in FIG. 2, the front plate 110 preferably includes a design layer 120. To be specific, the front plate 110 preferably includes the design layer 120 that overlaps the display region 1AA of the display panel 100 in a plan view. In the display device 1 having such an aspect, when the display device 1 is on, light emitted from the viewer's side of display panel 100 passes through the front plate 110 including the design layer 120 and is emitted to the viewer's side, so that the display device 1 allows the viewer to see color and pattern of the design layer 120. Furthermore, not only when the display device 1 is on but also when the display device 1 is off, the display device 1 allows the viewer to see the color and pattern of the design layer 120 by reflecting light (external light) incident on the display device 1 from the viewer's side.

Since the front plate 110 includes the design layer 120, the display device 1 looks just like a marble-patterned decorative plate when the display device 1 is off, and it does not look like there is the display panel 100 on the back side of the front plate 110. On the other hand, as illustrated in FIG. 3, when the display device 1 is on, an image (a string of letters ABCDE in FIG. 3) appears to emerge from the decorative plate, which provides very high design quality. By partially reducing the luminance of the display device 1 to such an extent that the pattern or the like of the design layer can be seen by the viewer due to reflected light, the viewer can see images and the like displayed on the display panel while seeing color of the front plate 110 and the color and pattern of the design layer 120. Note that when no design layer is provided, the viewer can see the color of the front plate 110 by, for example, coloring the front plate 110.

Here, when a front plate 110R included in a typical display device 1R including a display panel 100R includes a design layer, an appearance of a pattern when the display device 1R is off differs depending on a position, resulting in poor design. To be specific, an appearance of regions where adhesive members (double-sided tapes 301TR) are placed is different from an appearance of the other regions. Further, as illustrated in FIG. 4, when the display device 1R is on, the appearance of the pattern also differs depending on a position, resulting in poor design.

However, in the present embodiment, the front plate 110 includes the flat portion 110A that does not overlap the bezel 310, and the end portion 110B that overlaps the bezel 310, and at the end portion 110B, the distance between the viewer-side face 110X and the reference plane 100X is shorter than that at the flat portion 110A, and at least part of the adhesive member 301 overlaps the end portion 110B, so that the display device 1 can make the adhesive member 301 less visible both when the display device 1 is off and when the display device 1 is on, thereby achieving a good appearance.

The design layer 120 is a layer expressing a specific pattern or the like, and the pattern or the like is made visible to the viewer due to, for example, reflection of external light. The specific pattern is not particularly limited, and examples thereof include stylish geometric tones, carbon tones, marble tones, wood grain patterns, marble patterns, specific character strings, and company logos.

From the viewpoint of making a boundary between the display region 1AA and the frame region 1NA less visible, the design layer 120 is preferably placed so as to overlap the display region 1AA and the frame region 1NA of the display panel 100 in a plan view. In a plan view, the design layer 120 may be placed in only part of the front plate 110 but is preferably placed in the entire front plate 110.

The design layer 120 is, for example, a semi-transparent picture or pattern. The specific pattern is placed in the front plate 110 as the design layer 120 by semi-transparent printing or the like. For reference, when the pattern is a wood grain pattern, a transmittance of the design layer 120 is about 60 to 80%.

The design layer 120 may have a configuration described in, for example, JP 4184711 B. The design layer 120 preferably contains a reflective pigment. The reflective pigment is a pigment that reflects external light having a specific wavelength toward the viewer's side, and can make a specific color visible to the viewer depending on the wavelength of the reflected light. Note that the light having the specific wavelength is light in the visible light region (380 nm to 780 nm). The design layer 120 may contain reflective pigments of multiple colors, and by additive color mixing of the reflected light of the reflective pigments of multiple colors, a desired color can be seen to the viewer.

By containing a reflective pigment in the design layer 120, the front plate 110 can reflect at least part of light incident from the viewer's side. Since there are spaces between the pigments in the design layer 120, the front plate 110 can transmit at least part of light incident from the display panel 100 to the viewer's side.

The design layer 120 may be printed on a surface of the transparent base material 111 by a printing method such as gravure printing, screen printing, or ink-jet printing. Although FIG. 2 illustrates an example in which the design layer 120 is placed on the front side of the transparent base material 111, the design layer 120 may be placed on the back side of the transparent base material 111.

When the design layer 120 is placed on the back side of the transparent base material 111, the design layer 120 can be prevented from being scratched. By placing the transparent base material 111 on the viewer's side, depth sensation and glossiness are created, but depending on the pattern of the design layer 120, texture may be felt to be inferior due to the depth sensation and glossiness. From the viewpoint of being able to express the texture of the design layer 120 more vividly, it is preferable that the design layer 120 be placed on the front side of the transparent base material 111. On the other hand, when the design layer 120 is placed on the front side of the transparent base material 111, the design layer 120 is easily scratched, so that a hard coat layer (not illustrated) may be further provided on the front side of the design layer 120.

The adhesive member 301 is bonded to the front plate 110. The adhesive member 301 of the present embodiment is placed between the front plate 110 and the bezel 310, and bonds the bezel 310 and the front plate 110 together.

At least part of the adhesive member 301 overlaps the end portion 110B. The adhesive member 301 is placed, for example, along a periphery of the front plate 110. The adhesive member 301 preferably entirely overlaps the end portion 110B. The display device 1 having such an aspect can make the adhesive member 301 even less visible, thereby achieving a better appearance.

The adhesive member 301 is preferably placed on the back side face 110Y of the end portion 110B. The display device 1 having such an aspect can make the adhesive member 301 even less visible, thereby achieving a better appearance. To be specific, the adhesive member 301 is placed between the end portion 110B and the bezel 310.

In a plan view, a width of the adhesive member 301 is, for example, from 300 μm to 1.0 cm.

The adhesive member 301 is preferably transparent, black, or dark gray. To be specific, a reflectance of the adhesive member 301 measured from the viewer's side is preferably 30% or less. When the adhesive member 301 is transparent, a transmittance of the adhesive member 301 is preferably 70% or more. In this specification, the reflectance is a reflectance in a visible light region (e.g., wavelength 380 nm to 780 nm), and can be measured by a method in accordance with JIS R3106: 2019. As a measurement device, a spectrophotometer (e.g., CM-700d manufactured by KONICA MINOLTA, INC.) can be used.

The adhesive member 301 may include a base material and an adhesive layer provided on a surface of the base material. The base material and the adhesive layer are preferably transparent, black, or dark gray. To be specific, a reflectance of each of the base material and the adhesive layer is preferably 30% or less. When the base material and the adhesive layer are transparent, a transmittance of each of the base material and the adhesive layer is preferably 70% or more.

### Backlight

As illustrated in FIG. 2, the backlight 200 may be placed on the back side of the display panel 100. In particular, when the display panel 100 is a liquid crystal panel, the display device 1 preferably includes the backlight 200.

The backlight 200 may be any known type such as an edge-lit backlight in which light-emitting elements are arranged on an end face of a light guide plate, or a direct backlight in which a large number of light-emitting elements are arranged in a plane and uniformity is improved using a diffuser plate or the like. The light-emitting element may be any known type in the field of backlight such as a light emitting diode (LED), a fluorescent lamp, or a cold cathode tube.

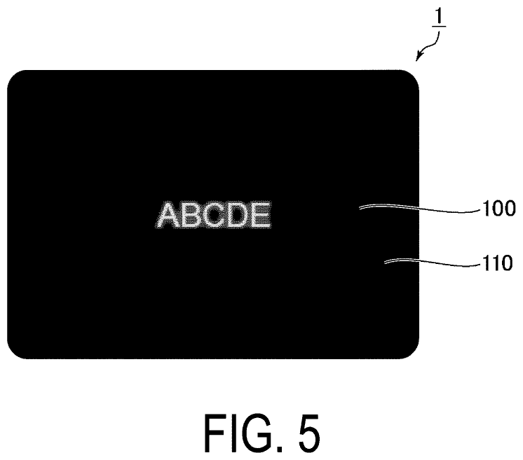

FIG. 5 is a schematic plan view of the display device according to the first embodiment, illustrating an aspect in which local dimming is possible. The display device 1 is preferably capable of local dimming. The local dimming, also referred to as partial drive, is a display method in which the display region 1AA is divided into multiple regions (dimming areas) and luminance (light emission intensity) is adjusted for each region.

When the display panel 100 is a liquid crystal panel, the display device 1 capable of local dimming preferably includes the backlight 200 capable of local dimming placed on the back side of the display panel 100. In this case, the backlight 200 is preferably a direct backlight. The display device 1 preferably further includes a luminance adjustment mechanism that adjusts luminance of the backlight 200. The luminance adjustment mechanism preferably adjusts emission intensity of each of the multiple light-emitting elements for divided regions in accordance with a display image of the display panel 100.

When the display panel 100 is a self-luminous panel, the display device 1 capable of local dimming preferably includes a luminance adjustment mechanism for self-luminous that adjusts luminance of this self-luminous panel. The luminance adjustment mechanism for self-luminance preferably adjusts emission intensity of each of multiple light-emitting elements arranged inside the display panel 100. Note that when a self-luminous panel such as an organic EL panel is used as the display panel, pixels in the off state are displayed in black, resulting in an appearance similar to that of the backlight placed on the back side of the liquid crystal panel being locally dimmed.

The local dimming can be used for achieving a sophisticated design of the display device 1 in which a picture (a string of letters ABCDE in FIG. 5) appears on a black background, as illustrated in FIG. 5. The local dimming changes brightness (luminance) of the backlight according to brightness of each dimming area of the display panel. In the dimming area where bright images and the like are displayed, the luminance of the backlight is increased, and in the dimming area where dark images and the like are displayed, the luminance of the backlight is decreased. In the dimming area where only black is displayed, the luminance of the backlight is further reduced or the backlight is turned off. In portions of the display region 1AA that are in a black display state, the same black color as when the backlight 200 is off can be achieved, thereby providing a good appearance. Note that in FIG. 5, difference in appearance between the display panel 100 and the bezel 310 is omitted.

### Housing

As illustrated in FIG. 2, the display device 1 includes the housing 300 that stores the display panel 100 and the backlight 200. The housing 300 includes a bottom 320 and the bezel 310 that is provided around the bottom 320 and protrudes toward the viewer's side. In a plan view, the bottom 320 overlaps the display panel 100, and the bezel 310 is placed around the display panel 100. For example, by placing the adhesive member 301 on the back side of the front plate 110 overlapping the frame region 1NA and bonding the adhesive member 301 to the bezel 310, the front plate 110 can be fixed to the housing 300.

The housing 300 may store, for example, a circuit substrate (not illustrated) on which a drive circuit for driving the display panel 100 and the backlight 200 is formed. The housing 300 is not particularly limited as long as the display panel 100 and the backlight 200 can be stored therein, and may be made of metal or resin. A shape of the housing 300 is not limited to a box shape with an open top as illustrated in FIG. 2. The bottom 320 and the bezel 310 may be integrally formed.

The bezel 310 preferably has a similar appearance to the display panel 100 when the display device 1 is off. To be specific, when the display panel 100 has an x value of x1 and a y value of y1 in an xy chromaticity diagram measured from the viewer's side in a state where the display device 1 is off, and the bezel 310 has an x value of x2 and a y value of y2 in an xy chromaticity diagram measured from the viewer's side, an absolute value of a difference between x1 and x2 and an absolute value of a difference between y1 and y2 are both preferably 0.02 or less. The display device 1 having such an aspect can make a boundary between the bezel 310 and the display panel 100 even less visible, thereby achieving a better appearance.

The bezel 310 preferably has a reflectance of 50% or less, and the display panel 100 preferably has a reflectance of 50% or less when the display device 1 is off. The display device 1 having such an aspect can achieve a sober appearance without being too flashy. Note that the reflectance of the display panel 100 when the display device 1 is off is a reflectance of the viewer-side face of the display panel 100 when the display device 1 is off.

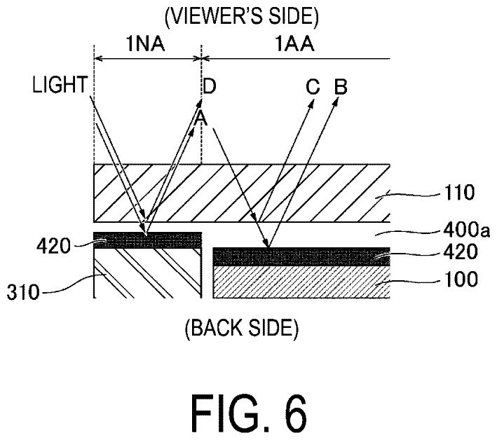

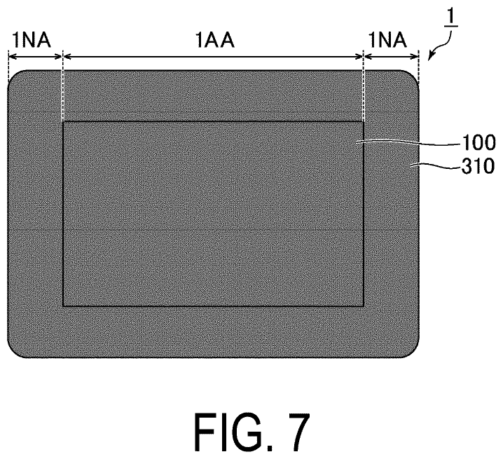

FIG. 6 is a schematic cross-sectional view of the display device according to the first embodiment, illustrating an aspect in which a component that is the same as a component on a viewer's side of the display panel is provided between the bezel and the front plate. FIG. 7 is a schematic plan view of the display device according to the first embodiment, illustrating the aspect in which the component that is the same as the component on the viewer's side of the display panel is provided between the bezel and the front plate.

The display device 1 of the present embodiment preferably includes, between the bezel 310 and the front plate 110, a component that is the same as a component on the viewer's side of the display panel 100. In the frame region 1NA, in a non-bonded portion where the adhesive member is not placed, the bezel 310 and the surface of the display panel 100 in the display region 1AA are visible to the viewer. An appearance of the non-bonded portion is affected not only by an interface reflection with an air layer but also by an appearance of the bezel surface. Therefore, when a material of the surface of the display panel 100 is different from a material of the surface of the bezel 310, appearances of the frame region 1NA and the display region 1AA are different from each other. In the present embodiment, by using the same material for a lower portion of the front plate 110, the appearances of the frame region 1NA and the display region 1AA of the display device 1 can be made closer to each other, thereby improving appearance.

When the display panel 100 is a liquid crystal panel, as illustrated in FIG. 6, a polarizer 420 may be placed on the viewer's side of the liquid crystal panel as the display panel 100. When the polarizer 420 is placed on the viewer's side of the liquid crystal panel, a polarizer 420 is preferably also placed between the bezel 310 and the front plate 110. The separate polarizers 420 may be placed on the viewer's side of the liquid crystal panel and between the bezel 310 and the front plate 110, or a single polarizer 420 may be placed so as to cover both the bezel 310 and the display panel 100. When the separate polarizers 420 are placed on the viewer's side of the liquid crystal panel and between the bezel 310 and the front plate 110, the polarizer 420 placed on the viewer's side of the liquid crystal panel and the polarizer 420 placed between the bezel 310 and the front plate 110 have the same in-plane polarization direction of, for example, a transmission axis and an absorption axis.

In addition, an AR film, an AG film, or the like may be further placed on the viewer's side of the polarizer 420 placed on the liquid crystal panel. In this case, a layered body of the polarizer 420 and an AR film or a layered body of the polarizer 420 and an AG film is preferably placed between the bezel 310 and the front plate 110. Separate AR films or AG films may be placed on the viewer's side of the liquid crystal panel and between the bezel 310 and the front plate 110, or a single AR film or AG film may be placed so as to cover both the bezel 310 and the display panel 100.

When the display panel is a self-luminous panel such as an OLED, a component of the display panel on the viewer's side is, for example, a glass plate (glass substrate). In this case, the glass plate is preferably also placed between the bezel 310 and the front plate 110.

In FIG. 6, A denotes a surface reflectance of the polarizer 420 placed between the bezel 310 and the front plate 110, B denotes a surface reflectance of the polarizer 420 placed on the viewer's side of the liquid crystal panel, C denotes an interface reflectance between the front plate 110 and an air layer 400a in the display region 1AA, and D denotes an interface reflectance between the front plate 110 and the air layer 400a in the frame region 1NA. C and D are the same because they are the interface reflectances between the same front plate 110 and the same air layer 400a. A and B are the same. That is, A+D=B+C, so that as illustrated in FIG. 7, the boundary between the display region 1AA and the frame region 1NA is even less visible than in the display device 1 illustrated in FIGS. 1 and 2, resulting in a better appearance.

### Display Method

When the display device 1 is on, light (display light) emitted from the display panel side passes through the front plate, is emitted to the viewer's side, and provides transmissive display that allows the viewer to view any image and the like displayed on the display panel. When the display panel is a liquid crystal panel, the transmissive display can be performed by turning on the backlight while the liquid crystal panel is in a white display state. By aligning the liquid crystal molecules so as to form an angle with the transmission axis of the polarizer, a white display state is obtained in which light emitted from the backlight is transmitted to the viewer's side, and when the orientation direction of the liquid crystal molecules forms an angle of 45° with the transmission axis of the polarizer, the transmittance is maximized. By aligning the liquid crystal molecules so as to be substantially parallel to the transmission axis of the polarizer, light transmitted to the viewer's side is blocked by the liquid crystal layer even when the backlight is on, resulting in a black display state.

### Modified Example of First Embodiment

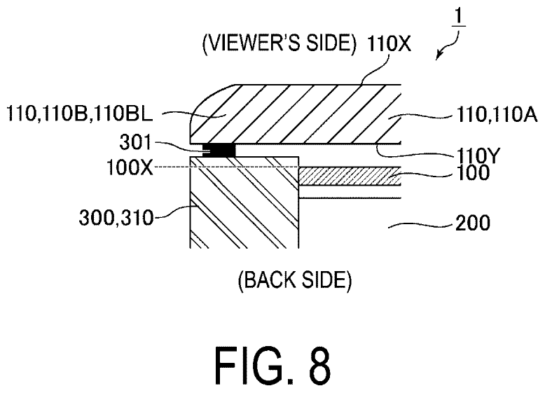

FIG. 8 is a schematic cross-sectional view of a display device according to a first modified example of the first embodiment. As illustrated in FIG. 8, an end portion 110B of this modified example is a lens portion 110BL. The display device 1 having such an aspect can make an adhesive member 301 even less visible due to refraction of light at the lens portion 110BL, thereby achieving a better appearance.

As the lens portion 110BL, a lens portion described in WO 2010/140537 can be used. A shape of a viewer-side face 110X of the lens portion 110BL will be described. For example, a line of intersection between the viewer-side face 110X of the lens portion 110BL and a plane perpendicular to a display surface (reference plane 100X) of a display panel 100 is a circular arc. The line of intersection between the viewer-side face 110X of the lens portion 110BL and the plane perpendicular to the display surface (reference plane 100X) may be a curve rather than a circular arc. In particular, the line of intersection is preferably a curve defined by an aspheric function described in WO 2009/157150. The disclosure of WO 2009/157150 is incorporated herein by reference.

The lens portion 110BL is a lens portion that, for example, compresses an image formed in a peripheral display region in a display region 1AA adjacent to a frame region 1NA by an image compression rate “a” compared with an image formed in a central display region located at the center of the display region 1AA, and displays the image formed in the peripheral display region enlarged by 1/a times on the viewer-side face 110X of the lens portion 110BL. A shape of the viewer-side face 110X of such a lens portion 110BL can be obtained as follows.

The following function is used as an aspheric function f(x).

$$f ( x ) = h - c {x}^{2} / ( 1 + {( 1 - ( 1 + k ) {c}^{2} {x}^{2} )}^{1 / 2} ) + {A}_{4} {x}^{4} + {A}_{6} {x}^{6} + {A}_{8} {x}^{8} + {A}_{10} {x}^{10} + …$$

where
c: a curvature of the lens portion 110BL (an inverse of a radius of curvature),
h: a thickness of a flat portion 110A (i.e., a distance 110AH), and
k: a conic constant. x indicates a position of each point on the viewer-side face 110X of the lens portion 110BL in a horizontal direction of a screen. A value of x is zero (0) on the central display region side and increases toward the frame region 1NA.

For example, where
a width L1 of the peripheral display region: 12 mm,
a width L2 of the frame region 1NA: 3 mm,
the image compression rate a: 0.8,
the thickness h of the flat portion 110A: 13 mm,
the radius of curvature (the inverse of the curvature c of the lens portion 110BL, 1/c): 23 mm, and
a refractive index n of the lens portion 110BL: 1.49 (acrylic resin);

$$k = 1.15 ,$$

$${A}_{4} = - 7.86 \times {10}^{- 7} ,$$

$${A}_{6} = 1 \text{.89} \times {10}^{- 8} ,$$

$${A}_{8} = - 1 \text{.62} \times {10}^{- 10} , and$$

$${A}_{10} = 4 \text{.95} \times {10}^{- 13} .$$

The value of k is given by the following equation.

$$k = 89.918 {a}^{4} - 194.57 {a}^{3} + 159.82 {a}^{2} - 57.099 a + 7.1865$$

Note that when the image compression rate is small (e.g., a<0.7), the value of 1/a becomes large, and each pixel is enlarged greatly. Therefore, a black matrix between the pixels can be conspicuous, resulting in poor display in many cases. When the image compression rate is large (e.g., a>0.9), a large lens portion is required relative to the width of the frame region, which is not preferable. For example, when the image compression rate a=0.95, a=L1/(L1+L2)=0.95, and thus the width (L1+L2) of the lens portion is 20 times the width L2 of the frame region. When the width L2 of the frame region is 3 mm as in the above example, the width L1+L2 of the lens portion is 60 mm. For example, in display devices for cellular phones, a width of the device is 60 mm or less in many cases, so that a lens member having a lens portion width of L1+L2 of 60 mm cannot be placed. Therefore, the image compression rate a is preferably about 0.7 to 0.9. By using the above equation, the conic constant k is calculated to be approximately 0.38 and 2.4 when the image compression rate a is 0.7 and 0.9, respectively, so that the preferred range for the conic constant k is from 0.38 to 2.4.

By calculating the aspheric function f(x) using the value of k and using the lens portion 110BL having the viewer-side face 110X represented by f(x), the lens portion 110BL effectively refracts light, and the display device 1 can effectively make the adhesive member 301 less visible, thereby achieving a better appearance.

Note that when a design layer 120 is placed at a back side face of the front plate 110, a pattern or the like of the design layer 120 is refracted by the lens portion 110BL, so that the pattern or the like at an end portion of the design layer 120 is not visible. However, since only a visible range of the pattern of the design layer 120 changes, the discomfort is small.

### Second Embodiment

In the present embodiment, features unique to the present embodiment will be mainly described, and description of contents that overlap with the above-described embodiment and the modified example thereof will be omitted. A display device in the present embodiment is substantially the same as the display device in the first embodiment except that the display device in the present embodiment includes a facing member that covers an end portion of a front plate.

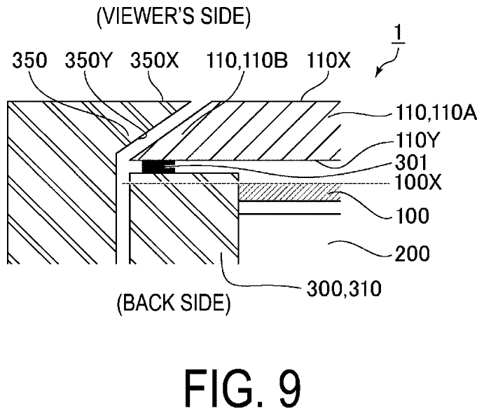

FIG. 9 is a schematic cross-sectional view of the display device according to a second embodiment. As illustrated in FIG. 9, a display device 1 of the present embodiment includes a facing member 350 that is placed on a viewer's side of an end portion 110B and overlaps the end portion 110B. The display device 1 having such an aspect can make an adhesive member 301 even less visible by the facing member 350, thereby achieving a better appearance. In addition, in the display device 1 having such an aspect, a good appearance can be achieved even when the end portion 110B is not lenticular in shape, thereby eliminating mechanical restrictions (such as a thickness of a front plate, a curved shape) that arise in order to produce a lens effect.

The facing member 350 may be part of a bezel 310.

The facing member 350 may overlap at least part of the end portion 110B. The facing member 350 preferably entirely overlaps the end portion 110B. The display device 1 having such an aspect can make the adhesive member 301 even less visible by the facing member 350, thereby achieving an even better appearance.

The facing member 350 preferably has an upper face 350X located on the same plane as a viewer-side face 110X of a flat portion 110A of a front plate 110, and a facing face 350Y provided along a viewer-side face 110X of the end portion 110B. The display device 1 having such an aspect can make the adhesive member 301 even less visible by the facing member 350 placed on the viewer's side of the adhesive member 301, thereby achieving a better appearance.

In the display device 1 of the present embodiment, the viewer-side face 110X of the end portion 110B and the facing face 350Y of the facing member 350 are inclined relative to a reference plane 100X. Thus, the end portion 110B with a gradually thinner film thickness is easier to manufacture and can achieve higher strength than an end portion 110B with a uniformly thin film thickness.

A viewer-side face of the facing member 350 preferably has a similar appearance to a display panel 100 when the display device 1 is off. To be specific, when the display panel 100 has an x value of x1 and a y value of y1 in an xy chromaticity diagram measured from the viewer's side in a state where the display device 1 is off, and the facing member 350 has an x value of x3 and a y value of y3 in an xy chromaticity diagram measured from the viewer's side, an absolute value of a difference between x1 and x3 and an absolute value of a difference between y1 and y3 are both preferably 0.02 or less. The display device 1 having such an aspect can achieve a better appearance.

Examples of the viewer-side face of the facing member 350 that has a similar appearance to the display panel 100 when the display panel 100 is off include the following aspects. For example, when the display panel 100 (image display unit) is printed with a wood grain tone or a wood grain tone sheet (front plate) is bonded to the display panel 100, the viewer-side face of the facing member 350 may be printed with a wood grain pattern, a wood grain tone sheet (front plate) may be bonded to the viewer-side face of the facing member 350, or a material constituting the facing member 350 may be wood.

The facing member 350 is preferably opaque. The display device 1 having such an aspect can make the adhesive member 301 even less visible, thereby achieving a better appearance. In this specification, being opaque means that a total light transmittance is from 0% to 30%, preferably from 0% to 20%, and more preferably from 0% to 10%.

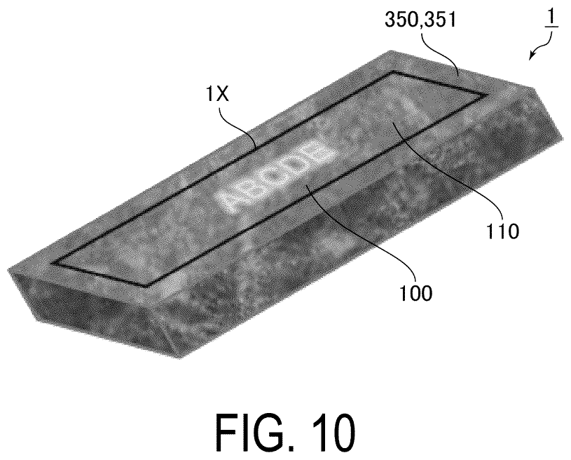

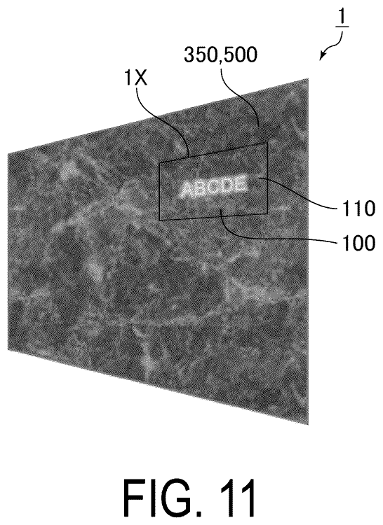

FIGS. 10 and 11 are schematic perspective views illustrating examples of the display device according to the second embodiment. As illustrated in FIGS. 10 and 11, the facing member 350 preferably has a similar appearance to the front plate 110. To be specific, the facing member 350 is preferably black or preferably has a design pattern similar to that of the front plate 110. The display device 1 having such an aspect can achieve a display that does not appear to be a display at first glance. For example, when a marbled design pattern is provided on the front plate 110 and the facing member 350, a display can be obtained that appears to be a marbled board at first glance, with an image appearing to emerge on the marbled board.

As illustrated in FIGS. 10 and 11, a gap 1X between the facing member 350 and the front plate 110 is visible, but by making the gap 1X very small, the gap 1X can be made less visible.

As illustrated in FIG. 10, the facing member 350 may be part of a component that stores a housing 300. That is, the display device 1 includes a storage section 351 that stores the housing 300, and the facing member 350 is part of the storage section 351.

A viewer-side face of the storage section 351 preferably has a similar appearance to the front plate 110. That is, when the storage section 351 has an x value of x4 and a y value of y4 in an xy chromaticity diagram measured from the viewer's side, and the front plate 110 has an x value of x5 and a y value of y5 in an xy chromaticity diagram measured from the viewer's side, an absolute value of a difference between x4 and x5 and an absolute value of a difference between y4 and y5 are both preferably 0.02 or less.

As illustrated in FIG. 11, the facing member 350 may be part of a large design plate (e.g., a wall surface 500). That is, the display device 1 is embedded in the wall surface 500, and the facing member 350 is part of the wall surface 500.

For example, the wall surface 500 including the facing member 350 may be given a design similar to that of the front plate 110, and the display panel 100 stored in the housing 300 may be embedded in the wall surface 500. The wall surface 500 preferably has a similar appearance to the front plate 110. That is, when the front plate 110 has an x value of x5 and a y value of y5 in an xy chromaticity diagram measured from the viewer's side, and the wall surface 500 has an x value of x6 and a y value of y6 in an xy chromaticity diagram measured from the viewer's side, an absolute value of a difference between x5 and x6 and an absolute value of a difference between y5 and y6 are both preferably 0.02 or less.

To achieve a similar appearance to that illustrated in FIG. 11, it is conceivable to enlarge the front plate 110, but since the front plate 110 is semi-transparent, tone adjustment of the material on a back face of the front plate 110 is necessary. In contrast, in the case of a method of embedding the display panel 100 stored in the housing 300 in the wall surface 500, the facing member 350 (wall surface 500) can be obtained by printing a design on an opaque material (e.g., resin, etc.), and thus, the facing member 350 can be easily manufactured.

### First Modified Example of Second Embodiment

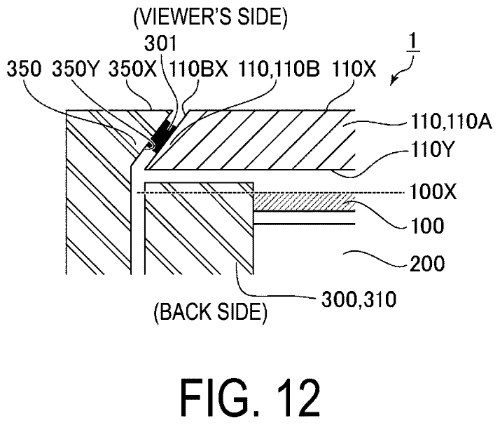

FIG. 12 is a schematic cross-sectional view of a display device according to a first modified example of the second embodiment. In the second embodiment, the adhesive member 301 is placed on a back side face 110Y of the end portion 110B, but a location where the adhesive member 301 is placed is not limited thereto. As illustrated in FIG. 12, the adhesive member 301 may be placed on a viewer-side face 110X of the end portion 110B. The display device 1 having such an aspect also provides effects similar to those of the display device of the second embodiment.

To be specific, an adhesive member 301 of this modified example is placed between an end portion 110B and a facing member 350. In the display device 1 of this modified example, a front plate 110 is not directly bonded to a bezel 310, so that by preparing multiple sets of facing members 350 to which front plates 110 are bonded, the front plates 110 having various designs can be replaced and combined with a display panel 100. Note that the facing member 350 is mechanically coupled to a housing 300 by screws, claws, or the like.

When the viewer-side face 110X of the end portion 110B has an inclined face 110BX that is inclined relative to a reference plane 100X, the adhesive member 301 of this modified example is preferably placed on the inclined face 110BX. The display device 1 having such an aspect can prevent the adhesive member 301 from being viewed, especially from an oblique direction.

### Second Modified Example of Second Embodiment

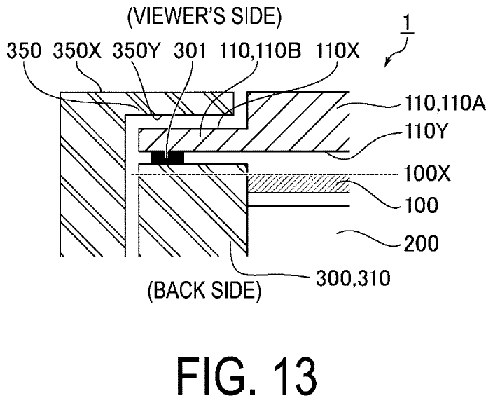

FIG. 13 is a schematic cross-sectional view of a display device according to a second modified example of the second embodiment. In the second embodiment, the viewer-side face 110X of the end portion 110B and the facing face 350Y of the facing member 350 are inclined relative to the reference plane 100X. On the other hand, in this modified example, as illustrated in FIG. 13, a viewer-side face 110X of an end portion 110B and a facing face 350Y of a facing member 350 are parallel to a reference plane 100X. The display device 1 having such an aspect also provides effects similar to those of the display device of the second embodiment.

### Third Embodiment

In the present embodiment, features unique to the present embodiment will be mainly described, and description of contents that overlaps with the above-described embodiments and the modified examples thereof will be omitted. A display device of the present embodiment is substantially the same as the display device of the second embodiment except that a shape of a front plate 110 is different.

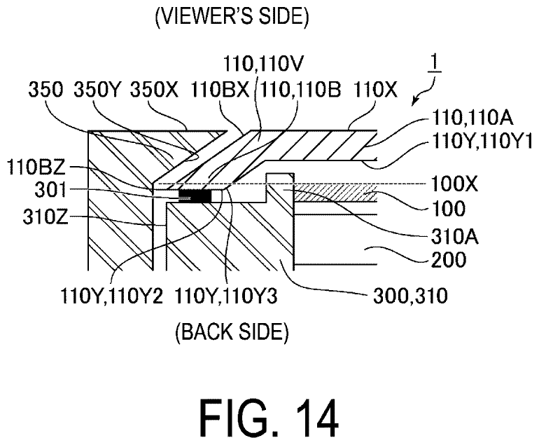

FIG. 14 is a schematic cross-sectional view of the display device according to a third embodiment. As illustrated in FIG. 14, a back side face 110Y of an end portion 110B of the present embodiment is located on a back side relative to a back side face 110Y of a flat portion 110A. A display device 1 having such an aspect can reduce a thickness of the front plate 110, thereby achieving a better appearance.

An effect of making an adhesive member 301 less visible depends on the thickness of the front plate 110. The thicker the front plate 110, the greater this effect, but an image is farther away from a surface of the display device 1, thereby degrading design. In addition, in a case in which the front plate 110 includes a design layer 120, the thicker the front plate 110, the stronger blurring of the image, resulting in reducing image quality.

In the present embodiment, the back side face 110Y of the end portion 110B is located on the back side relative to the back side face 110Y of the flat portion 110A, thereby enabling the display device 1 to make the adhesive member 301 less visible while reducing the thickness of the front plate 110 that overlaps an image display region (display region 1AA). In the display device 1 of the present embodiment, the thickness of the front plate 110 can be reduced, so that the image is close to the surface of the display device 1, which allows good design and good image quality with less blurring of the image.

To be more specific, a back side face 110Y of the front plate 110 of the present embodiment has a first face 110Y1 that overlaps at least part of the flat portion 110A and is parallel to a reference plane 100X, a second face 110Y2 that overlaps at least part of the end portion 110B, is parallel to the reference plane 100x, and is located on the back side relative to the first surface 110Y1, and a third face 110Y3 that is located between the first face 110Y1 and the second face 110Y2 and is not parallel to the reference plane 100X. The display device 1 having such an aspect can be achieved by providing a bending portion 110V in the front plate 110 having a substantially constant thickness, so that the adhesive member 301 can be made less visible more easily while reducing the thickness of the front plate 110 that overlaps the image display region (display region 1AA).

The back side face 110Y of the front plate 110 of the present embodiment is composed of the first face 110Y1, the second face 110Y2, and the third face 110Y3.

An angle between the third face 110Y3 and the reference plane 100X is preferably from 20° to 70°, more preferably from 30° to 60°, and even more preferably from 35° to 55°.

A bezel 310 includes a protruding portion 310A that protrudes toward a viewer's side in a region overlapping the flat portion 110A. In the display device 1 having such an aspect, since the front plate 110 can be bent at the protruding portion 310A, it is possible to effectively achieve a configuration in which the back side face 110Y of the end portion 110B is positioned on the back side relative to the back side face 110Y of the flat portion 110A, and it is possible to more easily make the adhesive member 301 less visible while reducing the thickness of the front plate 110 that overlaps the image display region (display region 1AA).

An edge portion 110BZ of the end portion 110B opposite to the display panel 100 overlaps an edge portion 310Z of the bezel 310 opposite to the display panel 100. In the display device 1 having such an aspect, the second face 110Y2 on which the adhesive member 301 is placed can be secured widely, so that the front plate 110 and the bezel 310 can be bonded more firmly to each other.

### First Modified Example of Third Embodiment

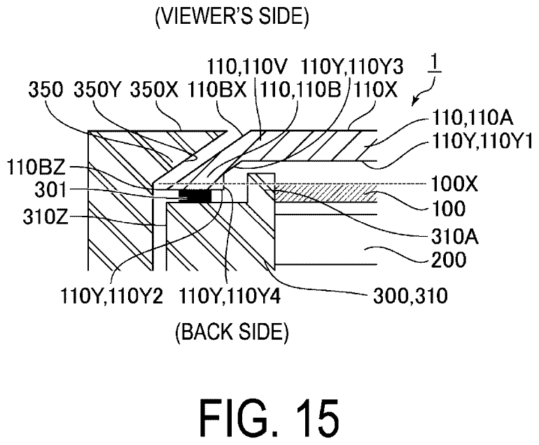

FIG. 15 is a schematic cross-sectional view of a display device according to a first modified example of the third embodiment. In the third embodiment, the back side face 110Y of the front plate 110 is composed of the first face 110Y1, the second face 110Y2, and the third face 110Y3. On the other hand, as illustrated in FIG. 15, a back side face 110Y of a front plate 110 of this modified example includes a first face 110Y1, a second face 110Y2, a third face 110Y3, and a fourth face 110Y4 that is located between the second face 110Y2 and the third face 110Y3 and is not parallel to a reference plane 100X. In a display device 1 having such an aspect, a thickness of the front plate 110 can be reduced, so that an image is close to a surface of the display device 1, which allows good design and good image quality with less blurring of the image.

An angle between the fourth face 110Y4 and the reference plane 100X is larger than an angle between the third face 110Y3 and the reference plane 100X. The angle between the fourth face 110Y4 and the reference plane 100X is preferably from 50° to 90°, more preferably from 60° to 90°, and even more preferably from 70° to 90°.

### Second Modified Example of Third Embodiment

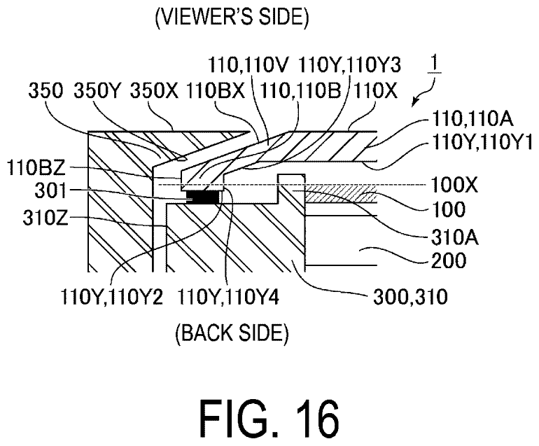

FIG. 16 is a schematic cross-sectional view of a display device according to a second modified example of the third embodiment. In the third embodiment, the edge portion 110BZ of the end portion 110B opposite to the display panel 100 overlaps the edge portion 310Z of the bezel 310 opposite to the display panel 100. On the other hand, in this modified example, as illustrated in FIG. 16, an edge portion 110BZ of an end portion 110B opposite to a display panel 100 is located closer to the display panel 100 side than an edge portion 310Z of a bezel 310 opposite to the display panel 100. In a display device 1 having such an aspect, a second face 110Y2 on which an adhesive member 301 is placed can be narrowed to reduce a placement area of the adhesive member 301, thereby achieving a better appearance.

### Third Modified Example of Third Embodiment

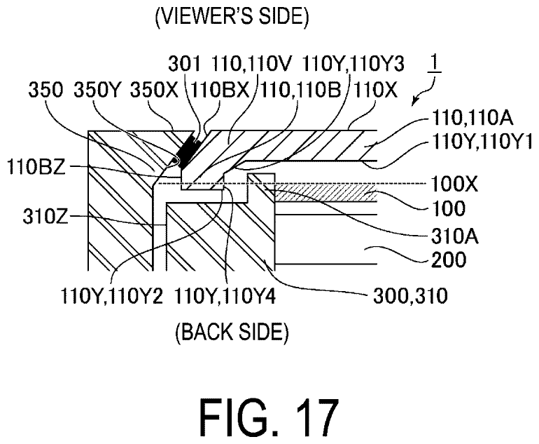

FIG. 17 is a schematic cross-sectional view of a display device according to a third modified example of the third embodiment. In the third embodiment, the adhesive member 301 is placed on the back side face 110Y of the end portion 110B, but a location where the adhesive member 301 is placed is not limited thereto. As illustrated in FIG. 17, an adhesive member 301 may be placed on a viewer-side face 110X of an end portion 110B. A display device 1 having such an aspect also provides effects similar to those of the display device of the third embodiment.

To be specific, the adhesive member 301 of this modified example is placed between the end portion 110B and a facing member 350. In the display device 1 of this modified example, a front plate 110 is not directly bonded to a bezel 310, so that by preparing multiple sets of facing members 350 to which front plates 110 are bonded, the front plates 110 having various designs can be replaced and combined with a display panel 100. Note that the facing member 350 is mechanically coupled to a housing 300 by screws, claws, or the like.

When the viewer-side face 110X of the end portion 110B has an inclined face 110BX that is inclined relative to a reference plane 100X, the adhesive member 301 of this modified example is preferably placed on the inclined face 110BX. The display device 1 having such an aspect can prevent the adhesive member 301 from being viewed, especially from an oblique direction.

### Fourth Embodiment

In the present embodiment, features unique to the present embodiment will be mainly described, and description of contents that overlaps with the above-described embodiments and the modified examples thereof will be omitted. A display device of the present embodiment is substantially the same as the display devices of the second embodiment and the third embodiment except that the display device of the present embodiment includes a light source placed between a front plate and a bezel, and a reflective layer placed along a viewer-side face of an end portion.

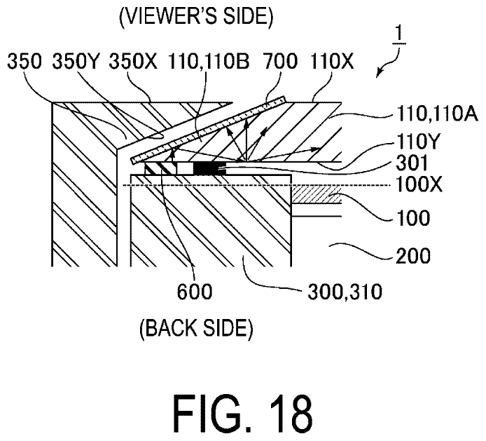

FIG. 18 is a schematic cross-sectional view of the display device according to the fourth embodiment. As illustrated in FIG. 18, a display device 1 according to the present embodiment includes a light source 600 placed between a front plate 110 and a bezel 310, and a reflective layer 700 placed along a viewer-side face 110X of an end portion 110B. The display device 1 having such an aspect can reflect light from the light source 600 at the reflective layer 700 (inclined face) and guide the light through the front plate 110. When the front plate 110 includes a design layer 120, each time light hits the design layer 120, the light is slightly scattered and part of the light is extracted. In this way, the front plate 110 serves as a light guide plate and can function as a front light.

In a plan view, the light source 600 preferably overlaps the end portion 110B and placed farther from a flat portion 110A than an adhesive member 301. In the display device 1 having such an aspect, the front plate 110 can more effectively function as a front light. The light source 600 is, for example, a light emitting diode flexible printed circuit (LED-FPC) in which multiple LEDs are arranged upward (to emit light toward the front plate 110).

The reflective layer 700 is preferably a total reflection layer. In the display device 1 having such an aspect, the front plate 110 can more effectively function as a front light. The reflective layer 700 is made of, for example, a polyester-based, such as an enhanced specular reflector (ESR), or PET-based white resin sheet, or a base material coated with white paint.

A display panel 100 of the present embodiment preferably is a reflective display panel. In the display device 1 having such an aspect, the front light function is more effectively exhibited. Examples of reflective display panels include reflective liquid crystal panels and e-paper panels.

Typical display devices according to first to third comparative embodiments will be described below with reference to the drawings. Front plates included in the display devices of the first to third comparative embodiments are different from those of the above-described embodiments in that the front plates do not include an end portion in which a distance between a viewer-side face and a reference plane is shorter than that in a flat portion. Note that a display panel 100R and a backlight 200R of the first to third comparative embodiments can be similar to the display panel 100 and the backlight 200 described in the first embodiment, and thus duplicated descriptions thereof will be omitted.

### First Comparative Embodiment

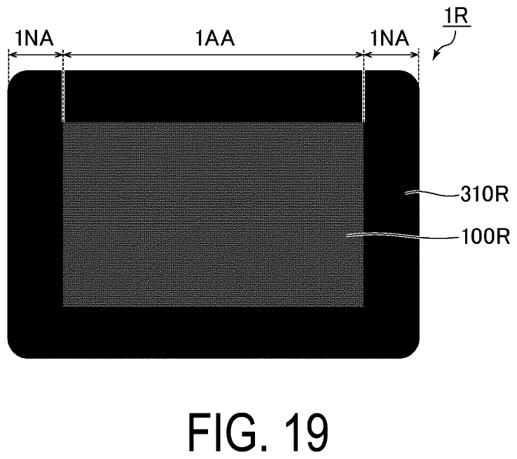

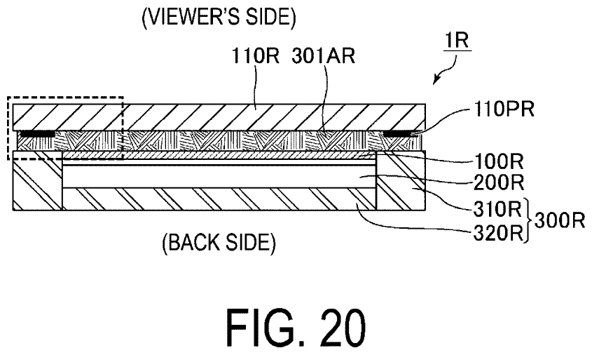

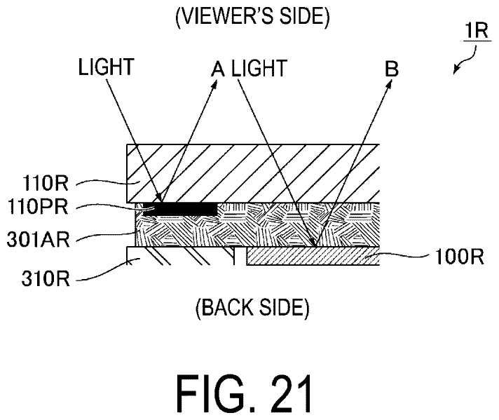

A display device 1R according to the first comparative embodiment is an example of a typical display device, and is a display device in which the display panel 100R and a front plate 110R are entirely bonded together with an optical clear adhesive sheet (hereinafter, also referred to as an OCA sheet) 301AR. FIG. 19 is a schematic plan view of the typical display device according to the first comparative embodiment. FIG. 20 is a schematic cross-sectional view of the typical display device according to the first comparative embodiment. FIG. 21 is an enlarged schematic cross-sectional view for describing reflection of external light in a region surrounded by a dotted line in FIG. 20.

In the display device 1R according to the first comparative embodiment, as illustrated in FIGS. 19 and 20, the display panel 100R with the backlight 200R placed on a back side thereof is stored in a housing 300R including a bezel 310R and a bottom 320R. A frame print portion 110PR is provided in a frame region 1NA of the front plate 110R using black ink or the like. The display panel 100R and the front plate 110R are bonded together with the OCA sheet 301AR. An example of the OCA sheet 301AR is LUCIACS (registered trademark, manufactured by Nitto Denko Corporation).

As illustrated in FIG. 20, in the display device 1R of the first comparative embodiment, the display panel 100R and the front plate 110R are entirely bonded together with the OCA sheet 301AR, and no air layer exists between the display panel 100R and the front plate 110R. Therefore, no interface reflection occurs between the front plate 110R and the air layer.

In the display device 1R of the first comparative embodiment, by making reflection characteristics of the frame print portion 110PR close to reflection characteristics of a display region 1AA when the display device 1R is off, the frame region 1NA can be made less noticeable. In FIG. 21, A denotes a surface reflectance of the frame print portion 110PR, and B denotes a surface reflectance of the display panel 100R. By adjusting the reflectance of the frame print portion 110PR such that the surface reflectance A of the frame print portion 110PR is equal to the surface reflectance B of the display panel 100R, appearance can be improved.

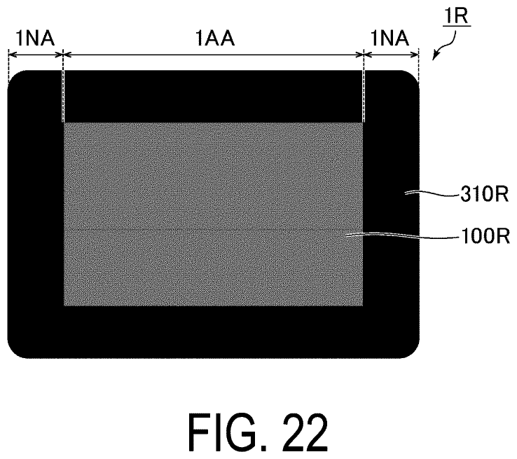

The display device 1R of the first comparative embodiment can have a lower reflectance of the display region 1AA than a display device according to a second comparative embodiment described below (see FIG. 22), and thus can make the display region 1AA darker as illustrated in FIG. 19, thereby making a boundary between the frame print portion 110PR and the display panel 100 less visible. On the other hand, in addition to high costs of the OCA sheet 301AR itself, a process of bonding the front plate 110R and the display panel 100R with the OCA sheet 301AR is usually performed under vacuum, which requires expensive vacuum bonding equipment and a large amount of work time, resulting in high manufacturing costs for the display device. In addition, when bonding with the OCA sheet 301AR, air bubbles or dust may enter. Further, the display panel 100R to which the front plate 110R is bonded may warp due to temperature changes. These concerns are particularly noticeable in large (e.g., 32 inches or larger) display devices.

### Second Comparative Embodiment

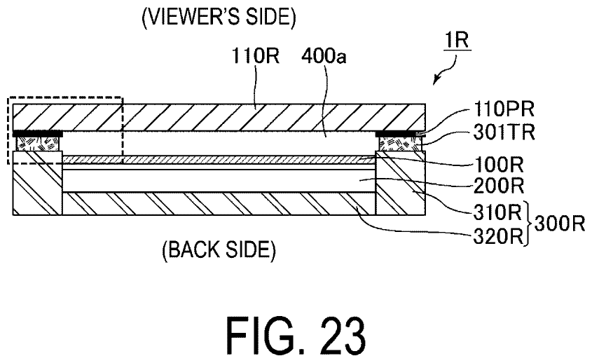

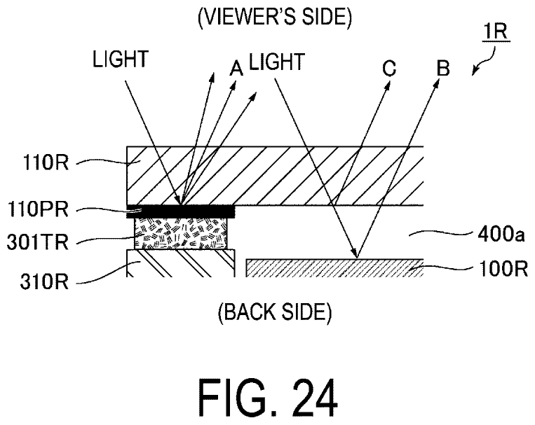

FIG. 22 is a schematic plan view of a typical display device according to the second comparative embodiment. FIG. 23 is a schematic cross-sectional view of the typical display device according to the second comparative embodiment. FIG. 24 is an enlarged schematic cross-sectional view for describing reflection of external light in a region surrounded by a dotted line in FIG. 23.

As illustrated in FIG. 23, a display device 1R according to the second comparative embodiment includes a frame print portion 110PR on a front plate 110R, and the front plate 110R and the display panel 100R are bonded together with double-sided tape 301TR provided in a frame region 1NA. Note that in the display device 1R of the second comparative embodiment, the double-sided tape 301TR is located on a back side of the frame print portion 110PR, so that a bonded portion where the double-sided tape 301TR is placed is not visible from the viewer's side. An example of the double-sided tape is Double-faced Adhesive Tape for Fixing of LCD Components 3800 Series, manufactured by SEKISUI CHEMICAL CO., LTD.

The display device 1R of the second comparative embodiment includes an air layer 400a between the front plate 110R and the display panel 100R, so that interface reflection occurs between the front plate 110R and the air layer 400a. In the second comparative embodiment, even when reflection characteristics of the frame print portion 110PR are made closer to reflection characteristics of a surface of a display region 1AA when not displayed, the frame print portion 110PR is more noticeable than in the first comparative embodiment because the air layer 400a exists at a position overlapping the display region 1AA.

In FIG. 24, A denotes a surface reflectance of the frame print portion 110PR, B denotes a surface reflectance of the display panel 100R, and C denotes an interface reflectance between the front plate 110R and the air layer 400a. In principle, when the surface reflectance of the frame print portion 110PR can be adjusted such that the surface reflectance A of the frame print portion 110PR is the sum of the surface reflectance B of the display panel 100R and the interface reflectance C between the front plate 110R and the air layer 400a, a boundary between the frame print portion 110PR and the display region 1AA can be less visible. However, while the surface reflection of the frame print portion 110PR is, for example, a light scattering reflection due to ink printed on the surface of the frame print portion 110PR, the interface reflection between the front plate 110R and the air layer 400a is a specular reflection, so that it is extremely difficult to bring the surface reflectance A close to the sum of the surface reflectance B and the interface reflectance C, including angular characteristics, and the frame region 1NA in which the frame print portion 110PR is placed is noticeable.

### Third Comparative Embodiment

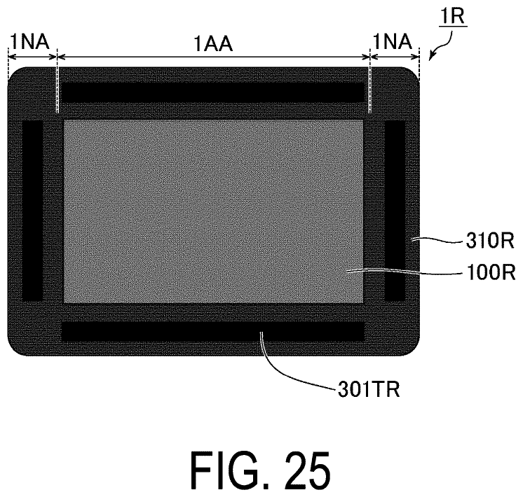

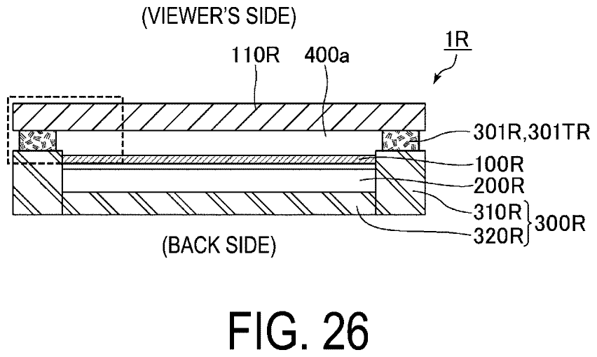

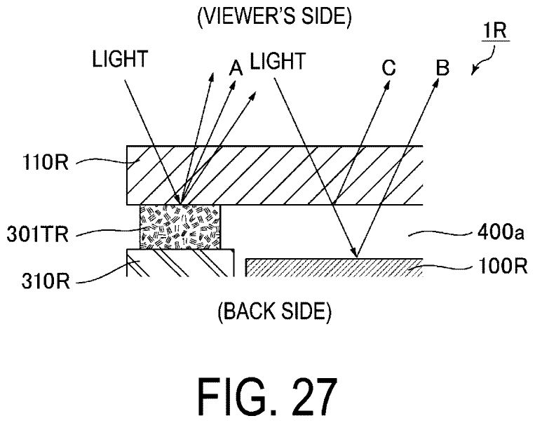

FIG. 25 is a schematic plan view of a typical display device according to a third comparative embodiment. FIG. 26 is a schematic cross-sectional view of the typical display device according to the third comparative embodiment. FIG. 27 is an enlarged schematic cross-sectional view for describing reflection of external light in a region surrounded by a dotted line in FIG. 26.

As illustrated in FIG. 26, in a display device 1R according to the third comparative embodiment, a frame print portion 110PR is not provided on a front plate 110R, and the front plate 110R and a bezel 310R are bonded together with an adhesive member 301R. As the adhesive member 301R, for example, the OCA sheet 301AR illustrated in the first comparative embodiment, or the double-sided tape 301TR illustrated in the second comparative embodiment can be used. The display device 1R of the third comparative embodiment includes an air layer 400a between the front plate 110R and the display panel 100R, so that interface reflection occurs between the front plate 110R and the air layer 400a.

In the display device 1R of the third comparative embodiment, in a non-bonded portion where the double-sided tape 301TR or the like is not placed, when a tone of the bezel 310R is made the same as a tone of a display region 1AA when the display device is off, a difference in appearance between the display region 1AA and the bezel 310R is less noticeable than that illustrated in the comparative embodiment 1. As the display region 1AA and the non-bonded portion of a frame region 1NA have an air layer on a back side of the front plate 110R, interface reflection between the front plate 110R and the air layer will occur. Note that in the display device 1R of the third comparative embodiment, a surface of the display panel 100R and a surface of the bezel 310R are also visible to the viewer, so that it is difficult to make the display region 1AA and the frame region 1NA look the same.

When an opaque component is used as the adhesive member 301R, reflection occurs on a surface of the opaque member at the bonded portion. On the other hand, when a transparent component is used as the adhesive member 301R, reflection occurs on the surface of the frame portion (bezel 310R) at the bonded portion. However, in either case, no interface reflection with the air layer occurs. Thus, reflections with different characteristics occur in the bonded portion and the non-bonded portion, resulting in a difference in appearance.

In FIG. 27, A denotes a surface reflectance of the double-sided tape 301TR, B denotes a surface reflectance of the display panel 100R, and C denotes an interface reflectance between the front plate 110R and the air layer 400a. In principle, by adjusting the reflectance of the double-sided tape 301TR (base material and adhesive layer) such that the surface reflectance A of the double-sided tape 301TR is the sum of the surface reflectance B of the display panel 100R and the interface reflectance C between the front plate 110R and the air layer 400a, a boundary between the display region 1AA and the frame region 1NA can be less visible. However, since the surface reflection of the double-sided tape 301TR is usually a light scattering reflection, and the interface reflection between the front plate 110R and the air layer 400a is a specular reflection, it is extremely difficult to bring the surface reflectance A close to the sum of the surface reflectance B and the interface reflectance C, including angular characteristics, and the frame region 1NA is noticeable.

Although the embodiments of the disclosure have been described above, the disclosure is not limited to the embodiments described above, and can be embodied in various aspects without departing from the gist thereof. The multiple constituent elements disclosed in the above embodiments can be modified as appropriate. For example, some of all the constituent elements illustrated in one embodiment may be added to the constituent elements of another embodiment, or some of all the constituent elements illustrated in one embodiment may be deleted from that embodiment. Each of the embodiments can also be combined.

The drawings mainly illustrate the corresponding constituent elements schematically in order to facilitate understanding of the disclosure, and the thickness, length, number, spacing, and the like of each of the constituent elements illustrated in the drawings may be different from the actual ones for convenience of drawing preparation. The configurations of the constituent elements illustrated in the above-described embodiments are merely examples and are not particularly limited, and it is needless to say that various modifications can be made without substantially departing from the effects of the disclosure.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

1. A display device comprising:
a display panel;
a housing configured to store the display panel and including a bezel placed around the display panel in a plan view;
a front plate placed on a viewer's side of the display panel, at least part of the front plate overlapping the bezel; and
an adhesive member bonded to the front plate,
wherein the front plate includes a flat portion not overlapping the bezel and an end portion overlapping the bezel,
in a case in which a plane obtained by virtually expanding a viewer-side face of the display panel is defined as a reference plane, a distance between a viewer-side face of the end portion and the reference plane is shorter than a distance between a viewer-side face of the flat portion and the reference plane, and
at least part of the adhesive member overlaps the end portion.

2. The display device according to claim 1,
wherein the viewer-side face of the end portion is inclined relative to the reference plane.

3. The display device according to claim 1,
wherein the distance between the viewer-side face of the end portion and the reference plane increases toward the flat portion.

4. The display device according to claim 1,
wherein the front plate does not include a light blocking portion.

5. The display device according to claim 1,
wherein in a case in which the display panel has an x value of x1 and a y value of y1 in an xy chromaticity diagram measured from the viewer's side in a state where the display device is off, and the bezel has an x value of x2 and a y value of y2 in an xy chromaticity diagram measured from the viewer's side, an absolute value of a difference between x1 and x2 and an absolute value of a difference between y1 and y2 are both 0.02 or less.

6. The display device according to claim 1,
wherein a reflectance of the bezel is 50% or less, and a reflectance of the display panel is 50% or less in a state where the display device is off.

7. The display device according to claim 1, further comprising:
a component between the bezel and the front plate, the component being identical to a component located closest to a viewer's side in the display panel.

8. The display device according to claim 1,
wherein the adhesive member is placed on a back side face of the end portion.

9. The display device according to claim 1,
wherein the adhesive member is placed on the viewer-side face of the end portion.

10. The display device according to claim 8,
wherein the end portion is a lens portion.

11. The display device according to claim 8, further comprising:
a facing member placed on the viewer's side of the end portion and overlaps the end portion.

12. The display device according to claim 11,
wherein in a case in which the display panel has an x value of x1 and a y value of y1 in an xy chromaticity diagram measured from the viewer's side in a state where the display device is off, and the facing member has an x value of x3 and a y value of y3 in an xy chromaticity diagram measured from the viewer's side, an absolute value of a difference between x1 and x3 and an absolute value of a difference between y1 and y3 are both 0.02 or less.

13. The display device according to claim 11, further comprising:
a storage section configured to store the housing,
wherein the facing member is part of the storage section.

14. The display device according to claim 13,
wherein in a case in which the storage section has an x value of x4 and a y value of y4 in an xy chromaticity diagram measured from the viewer's side, and the front plate has an x value of x5 and a y value of y5 in an xy chromaticity diagram measured from the viewer's side, an absolute value of a difference between x4 and x5 and an absolute value of a difference between y4 and y5 are both 0.02 or less.

15. The display device according to claim 11,
wherein the display device is embedded in a wall surface, and
the facing member is part of the wall surface.

16. The display device according to claim 15,
wherein in a case in which the front plate has an x value of x5 and a y value of y5 in an xy chromaticity diagram measured from the viewer's side, and the wall surface has an x value of x6 and a y value of y6 in an xy chromaticity diagram measured from the viewer's side, an absolute value of a difference between x5 and x6 and an absolute value of a difference between y5 and y6 are both 0.02 or less.

17. The display device according to claim 8,
wherein the back side face of the end portion is located on a back side relative to a back side face of the flat portion.

18. The display device according to claim 1,
wherein the front plate includes a design layer.

19. The display device according to claim 1,
wherein local dimming is possible.
